(19) United States
(12) Patent Application Publication
(10) Pub. No.: US 2005/0236434 A1
(43) Pub. Date: Oct. 27, 2005

(54) Dispenser

(75) Inventor: Stanley George Bonney, Research Triangle Park, NC (US)

Correspondence Address: GLAXOSMITHKLINE;CORPORATE INTELLECTUAL PROPERTY, MAI B475, FIVE MOORE DR., PO BOX 13398, RESEARCH TRIANGLE PARK, NC, 27709-3398, US

(73) Assignee: Glaxo Group Limited, Greenford, Middlesex (GB)

(21) Appl. No.: 10/523,053

(22) PCT Filed: Aug. 4, 2003
(86) PCT No.: PCT/EP03/08646

§ 371 Date: Feb. 2, 2005

(30) Foreign Application Priority Data
Aug. 6, 2002 (GB) 0218251.7
Dec. 18, 2002 (GB) 0229472.6

(51) Int. Cl. G01F 11/00

(52) U.S. Cl. 222/386

(57) ABSTRACT

A dispenser for dispensing a metered volume of a fluid product having a storage chamber for storing the fluid product in; an outlet orifice through which the fluid product is dispensable from the dispenser; and a dispensing mechanism adapted in use to dispense a metered volume of the fluid product from the storage chamber through the outlet orifice is disclosed. The dispensing mechanism has a metering chamber which is adapted in use to provide the metered volume of the fluid product for discharge through the outlet orifice. The metering chamber is movable between a first volumetric state, in which the metering chamber has a first volume greater than the metered volume and is in fluid communication with the storage chamber such that, in use, an excess volume of the fluid product consisting of the metered volume and a surplus volume is transferable to the metering chamber from the storage chamber, and a second volumetric state, in which the metering chamber has a second volume less than the first volume and no less than the metered volume and is isolated from the storage chamber such that, in use, the metered volume of the fluid product is contained in the metering chamber ready for dispensing through the outlet orifice.

### RELATED APPLICATION

This application claims priority from UK patent application Nos. 0218251.7 and 0229472.6, filed respectively on 6 Aug. 2002 and 18 Dec. 2002, the entire contents of which are hereby incorporated herein by reference.

### FIELD OF THE INVENTION

The present invention relates to a dispenser for dispensing a metered volume of a fluid product and is particularly, but not exclusively, concerned with a dispenser for dispensing a metered volume of a fluid medicament, for instance medicaments having liquid, gaseous, powder or topical (cream, paste etc.) formulations. The invention also has application in the area of consumer healthcare, as in the case of toothpaste, sun cream lotion etc.

### BACKGROUND OF THE INVENTION

Fluid product dispensers having metering mechanisms are known in the art. As an example, in the medical field the use of metered dose inhalers (MDIs) is well established. In a MDI, the fluid product is contained under pressure in a canister having an open end closed off by a valve mechanism. The valve mechanism has a valve body which defines a fixed volume metering chamber through which a valve stem is sealingly slidable between filling and discharging positions. In the filling position, the valve stem places the metering chamber in fluid communication with the canister contents, but isolates the metering chamber from the external environment. Conversely, when the valve stem is moved to the discharge position, the metering chamber is placed in fluid communication with the external environment, but isolated from the canister contents. In this way, a metered volume of fluid product is sequentially transferred to the metering chamber and then discharged to the external environment for inhalation by a patient.

The present invention provides a dispenser for a fluid product having a novel dispensing mechanism.

### SUMMARY OF THE INVENTION

According to the present invention there is a provided a dispenser for dispensing a metered volume of a fluid product having a storage chamber for storing the fluid product in; an outlet orifice through which the fluid product is dispensable from the dispenser; and a dispensing mechanism adapted in use to dispense a metered volume of the fluid product from the storage chamber through the outlet orifice; the dispensing mechanism having:
(i) a metering chamber which is adapted in use to provide the metered volume of the fluid product for discharge through the outlet orifice, the metering chamber being movable between:
   a first volumetric state, in which the metering chamber has a first volume greater than the metered volume and is in fluid communication with the storage chamber such that, in use, an excess volume of the fluid product consisting of the metered volume and a surpJus volume is transferable to the metering chamber from the storage chamber, and
   a second volumetric state, in which the metering chamber has a second volume less than the first volume and no less than the metered volume and is isolated from the storage chamber such that, in use, the metered volume of the fluid product is contained in the metering chamber ready for dispensing through the outlet orifice; and
(ii) a bleed arrangement adapted in use to bleed the surplus volume of the fluid product from the metering chamber as its moves from the first volumetric state to the second volumetric state.

Preferred features of the invention are set forth in the subordinate claims appended hereto, as well as in the exemplary embodiment hereinafter to be described.

### BRIEF DESCRIPTION OF THE DRAWINGS

The FIGURES of drawings are schematic, partial cross-sectional views of a dispenser according to the present invention in which:

FIG. 1 shows the dispenser in a rest mode;

FIG. 2 shows the dispenser in a filling mode of operation; and

FIGS. 3 to 5 show the dispenser in various stages of a dispensing mode of operation.

### DESCRIPTION OF THE EXEMPLARY EMBODIMENT OF THE INVENTION

In the FIGURES a hand-held, hand-operable dispenser 1 according to the present invention is shown. The dispenser 1 may be used as a medicament dispenser, for example as an intranasal delivery device.

The dispenser 1 has a housing 2 which houses a container member 3 comprising a tubular body 5 in which an end wall 7 is sealingly slidable. The inner surfaces of the tubular body 5 and end wall 7 define a storage chamber 9 in which the fluid product 10 to be dispensed, a medicament for instance, is contained. The tubular body 5 has a port 11 at its end opposite to that which receives the sliding end wall 7.

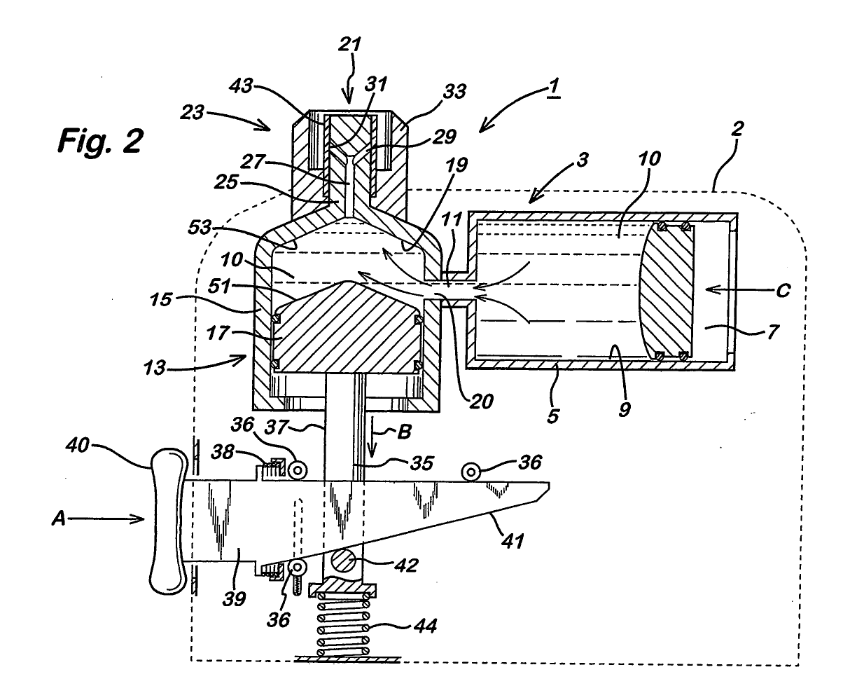

The dispenser 1 further comprises a metering member 13 having a tubular body 15 and an end wall 17 which is sealingly slidable in the tubular body 15. As can be seen from FIG. 2, for example, a metering chamber 19 is defined between the inner surfaces of the tubular body 15 and the end wall 17. As will be described in more detail hereinafter, the metering chamber 19 operates to provide a metered volume of the fluid product 10 for discharge from the dispenser 1.

In a side of the tubular body 15 of the metering member 13 there is provided a port 20 which registers with the port 11 of the container member 3 thereby placing the storage and metering chambers 9, 19 in fluid communication with one another whereby the fluid product 10 can be transferred from the storage chamber 9 to the metering chamber 19 for subsequent discharge from the dispenser 1.

The metering chamber 19 communicates with an outlet orifice 21 of a spray head 23, which, in this embodiment, is shaped and sized for insertion into a user's nostril. The tubular body 15 of the metering member 13 includes an extension 25 through which a narrow channel 27 extends to connect the outlet orifice 21 to the metering chamber 19. The channel 27 has a branched end 29 so as to form an annular outlet port 31 in the outlet orifice 21. The spray head 23 further includes a skirt member 33 mounted on the tubular body 15 about the extension 25 which acts to focus the spray stream discharged through the annular outlet port 31.

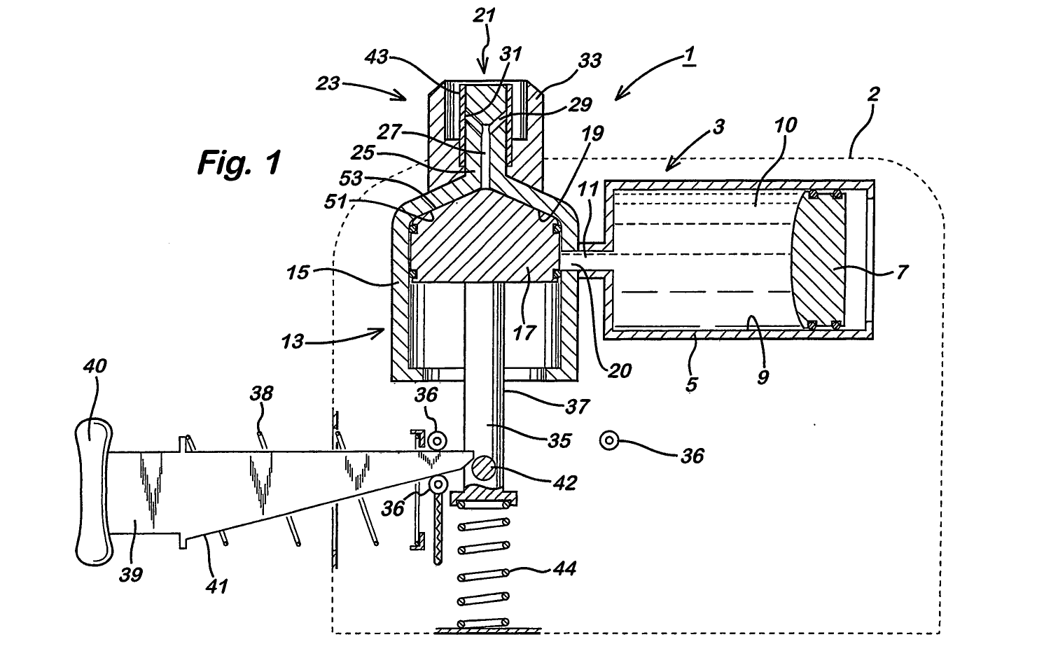

The end wall 17 of the metering member 13 forms the head of a spring-loaded plunger member 35 of a hand-operable actuating mechanism of the dispenser 1. The plunger member 35 further has an arm 37 on which a spring 44 acts to bias the plunger member 35 to the rest or return position shown in FIG. 1. The arm 37 is operatively connected to a trigger member 39 of the actuating mechanism, the trigger member 39 having a grip or button 40 for a user of the dispenser 1 to grip with a hand, or press with a finger or thumb, to operate the actuating mechanism. The trigger member 39 is mounted for sliding movement in the dispenser 1 in a direction transverse to the direction of sliding movement of the plunger member 35. In this connection, the dispenser 1 has guides 36 for guiding the sliding movement of the trigger member 39. Moreover, the trigger member 39 is spring-loaded with a spring 38 which biases the trigger member 39 to its extended position shown in FIG. 1.

As will be understood from FIG. 2, the trigger member 39 has a camming surface 41 which, when the trigger member 39 is moved inwardly (arrow A), acts on a cam follower 42 provided on the arm 37 of the plunger member 35 so as to displace the plunger member 35 rearwardly (arrow B) to a primed position, as shown. This is the filling mode of the dispenser 1 in the sense that rearward movement of the plunger member 35 causes a pressure difference between the metering chamber 19 and the storage chamber 9 which causes the end wall 7 of the container member 3 to be displaced inwardly (arrow C) thereby pushing fluid product 10 from the storage chamber 9 into the metering chamber 19 for filling thereof.

A non-return valve 43 is mounted at the outlet orifice 21 about the extension 25 of the tubular body 15 of the metering member 13. The non-return valve 43 is in the form of a sleeve member. The negative pressure created in the metering chamber 19 as the plunger member 35 is retracted from the rest position shown in FIG. 1 causes the valve 43 to be biased to a closed position in which it seals off the annular outlet port 31.

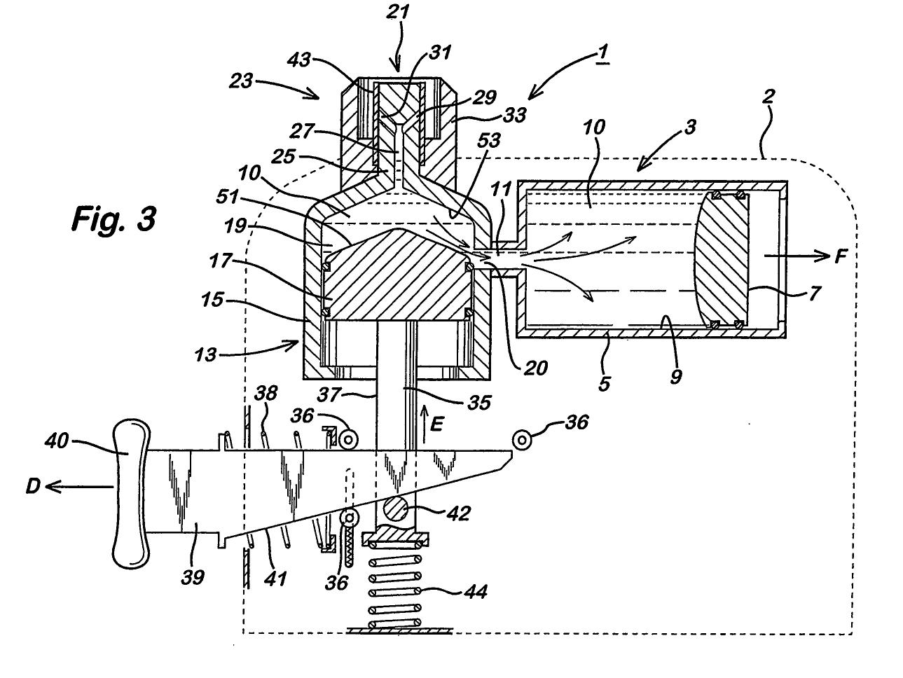

Referring to FIGS. 3 to 5, once the dispenser 1 has been primed, by inward movement of the trigger member 39 causing retraction of the plunger member 35 to the rearwardmost primed position and compression of the springs 38,44, the dispenser 1 can be actuated by releasing the inward force on the trigger member 39. This releases the loading on the spring 38 allowing it to drive the trigger member 39 outwardly (arrow D) whereupon the plunger member 35 is released from capture by the trigger member 39 and driven forwardly by the spring member 44 (arrow E). This is the discharge mode of the dispenser 1.

The initial stage or phase of the discharge mode is shown in FIG. 3. In this initial stage, the forward movement of the plunger member 35 pushes surplus fluid product 10 received in the metering chamber 19 in the filling mode back into the storage chamber 9 through the communicating ports 11, 20. In this regard, the bleeding of the surplus fluid product is accommodated by outward sliding movement of the end wall 7 of the container member 3 (arrow F) responsive to the increase in pressure in the storage chamber 9 as the surplus fluid product is received therein.

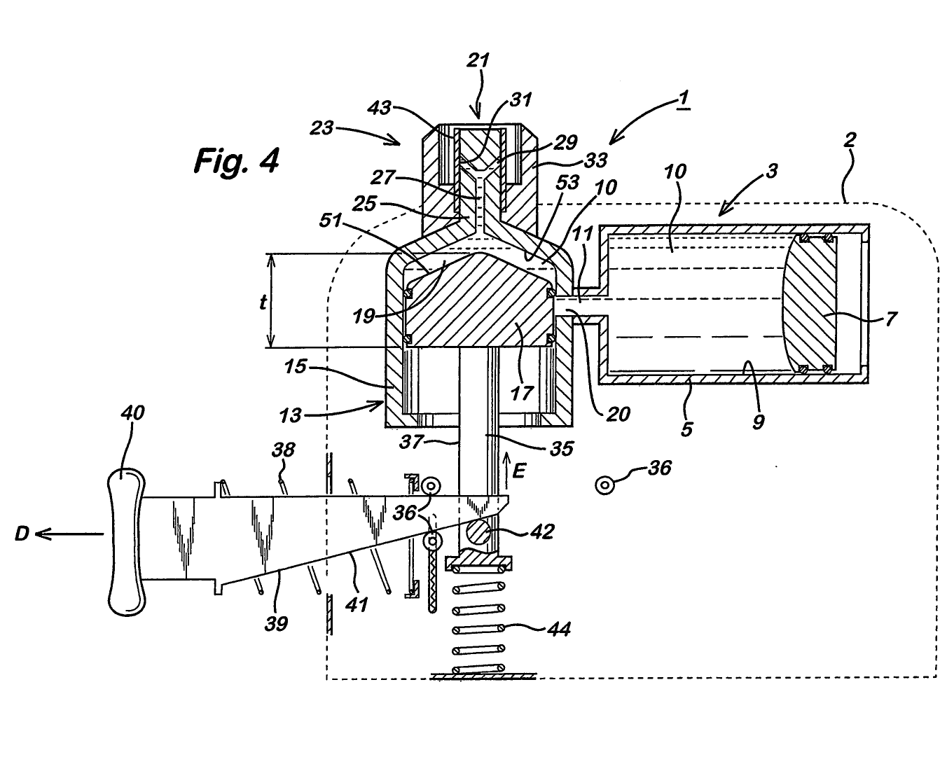

As will be understood from FIG. 4, as the plunger member 35 is slid forwardly it reaches an intermediate position at which the plunger head 17 closes off the port 20 thereby sealing the metering chamber 19 from the storage chamber 9. The end wall 7 of the container member 3 is adapted to move outwardly at a lower pressure than the valve 43 thereby ensuring that during movement of the plunger member 35 from its rearwardmost primed position to the intermediate position surplus fluid product is transferred back to the storage chamber 9, not discharged from the outlet orifice 21.

At the intermediate position in the discharge mode of the dispenser 1, shown in FIG. 4, the metering chamber 19 defines a predetermined volume filled with the fluid product 10. This is the “metered volume” of fluid product to be dispensed by the dispenser 1.

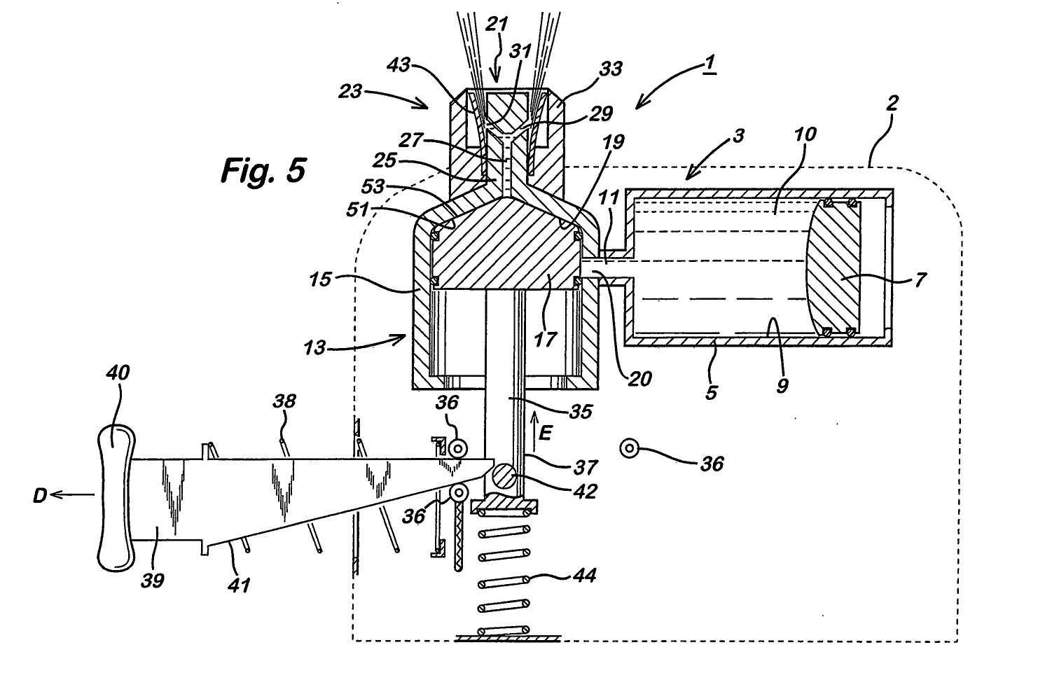

As shown in FIG. 5, onward forward movement of the plunger member 35 forces open the valve 43 and causes discharge of the metered volume of the fluid product from the annular outlet port 31 of the outlet orifice 21. The narrow dimensions of the channel 27 and annular outlet port 31 cause the discharged fluid product to be in the form of a spray stream if liquid is being dispensed.

Once the spring member 44 has returned the plunger member 35 to its forwardmost rest position, the pressure pulse which caused the valve 43 to open subsides whereby an inherent bias in the material of the valve 43 biases it back to its closed position over the annular outlet port 31.

As shown in FIGS. 1 and 5, the plunger head 17 has a front face 51 which sealingly closes the channel 27 to the outlet orifice 21 when the plunger member 35 is in the rest position. Moreover, in this embodiment, the front face 51 is of complementary shape to the front section 53 of the metering chamber 19 in which the channel 27 opens. In other words, the front face 51 sealingly engages the front section 53.

As will be seen from FIG. 4, the plunger head 17 has a thickness t which is such that it maintains the port 20 in a closed state as it moves from the intermediate position to the forwardmost position. In this manner, fluid product 10 in the storage chamber 9 is unable to be transferred behind the plunger member 35, nor is fluid product 10 able to drain back from the metering chamber 19 to the storage chamber 9.

It will therefore be understood that a sealed system is achieved since the storage chamber 9 is sealed from the external environment about the dispenser 1.

After the metered volume has been dispensed, the dispenser 1 is left in the rest mode shown in FIG. 1 until such time as another metered volume is required to be dosed.

To refill the metering chamber 19, the trigger member 39 is reengaged with the plunger member 35 so as to cam the plunger member 35 rearwardly. After the plunger member 35 has passed the intermediate position on its rearward travel, the port 20 is opened whereby the fluid product 10 can be transferred from the storage chamber 9 to the metering chamber 19 in the manner previously described preparatory to dispensing a further metered volume of the fluid product. After each actuation cycle, the volume of the storage chamber 9 decreases commensurate with the diminution of the volume of fluid product, i.e. by the metered volume. This is because during the initial phase of a discharge mode, the end wall 7 of the container member 3 is pushed back to a position closer to the port 11 than that at the start of the filling mode.

The dispenser 1 provides for high accuracy dosing from a sealed system which protects the fluid product 10 from contamination from the external environment. For instance, the non-return valve 43 prevents air ingress. Moreover, the storage chamber 9 is isolated from the outlet orifice 21 during the rest, filling and discharge modes, initially by the valve 43, then latterly by the plunger head 17. Accordingly, the fluid product 10 can be preservative-free, of particular benefit when the fluid product is a medicament.

The dispenser 1 further dispenses without the need for a dip tube, and gives no drain back.

Where the dispenser of the invention is a medicament dispenser, for instance an intra-nasal medicament dispenser, administration of the medicament may be indicated for the treatment of mild, moderate or severe acute or chronic symptoms or for prophylactic treatment.

Appropriate medicaments may thus be selected from, for example, analgesics, e.g., codeine, dihydromorphine, ergotamine, fentanyl or morphine; anginal preparations, e.g., diltiazem; antiallergics, e.g., cromoglycate (e.g. as the sodium salt), ketotifen or nedocromil (e.g. as the sodium salt); antiinfectives e.g., cephalosporins, penicillins, streptomycin, sulphonamides, tetracyclines and pentamidine; antihistamines, e.g., methapyrilene; anti-inflammatories, e.g., beclomethasone (e.g. as the dipropionate ester), fluticasone (e.g. as the propionate ester), flunisolide, budesonide, rofleponide, mometasone (e.g. as the furoate ester), ciclesonide, triamcinolone (e.g. as the acetonide), 6α,9α-difluoro-11β-hydroxy-16α-methyl-3-oxo-17α-propionyloxy-androsta-1,4-diene-17β-carbothioic acid S-(2-oxo-tetrahydro-furan-3-yl)ester or 6α,9α-Difluoro-17α-[(2-furanylcarbonyl)oxy]-11β-hydroxy-16α-methyl-3-oxo-androsta-1,4-diene-17β-carbothioic acid S-fluoromethyl ester; antitussives, e.g., noscapine; bronchodilators, e.g., albuterol (e.g. as free base or sulphate), salmeterol (e.g. as xinafoate), ephedrine, adrenaline, fenoterol (e.g. as hydrobromide), formoterol (e.g. as fumarate), isoprenaline, metaproterenol, phenylephrine, phenylpropanolamine, pirbuterol (e.g. as acetate), reproterol (e.g. as hydrochloride), rimiterol, terbutaline (e.g. as sulphate), isoetharine, tulobuterol or 4-hydroxy-7-[2-[[2-[[3-(2-phenylethoxy)propyl]sulfonyl]ethyl]amino]ethyl-2(3H)-benzothiazolone; PDE4 inhibitors e.g. cilomilast or roflumilast; leukotriene antagonists e.g. montelukast, praniukast and zafirlukast; [adenosine 2a agonists, e.g. 2R,3R,4S,5R)-2-[6-Amino-2-(1S-hydroxymethyl-2-phenyl-ethylamino)-purin-9-yl]-5-(2-ethyl-2H-tetrazol-5-yl)-tetrahydro-furan-3,4-diol (e.g. as maleate)]; [α4 integrin inhibitors e.g. (2S)-3-[4-({[4-(aminocarbonyl)-1-piperidinyl]carbonyl}oxy)phenyl]-2-[((2S)-4-methyl-2-{[2-(2-methylphenoxy)acetyl]amino}pentanoyl)amino]propanoic acid (e.g. as free acid or potassium salt)], diuretics, e.g., amiloride; anticholinergics, e.g., ipratropium (e.g. as bromide), tiotropium, atropine or oxitropium; hormones, e.g., cortisone, hydrocortisone or prednisolone; xanthines, e.g., aminophylline, choline theophyllinate, lysine theophyllinate or theophylline; therapeutic proteins and peptides, e.g., insulin or glucagons. It will be clear to a person skilled in the art that, where appropriate, the medicaments may be used in the form of salts, (e.g., as alkali metal or amine salts or as acid addition salts) or as esters (e.g., lower alkyl esters) or as solvates (e.g., hydrates) to optimise the activity and/or stability of the medicament and/or to minimise the solubility of the medicament in the propellant.

Preferably, the medicament is an anti-inflammatory compound for the treatment of inflammatory disorders or diseases such as asthma and rhinitis.

The medicament may be a glucocorticoid compound, which has anti-inflammatory properties. One suitable glucocorticoid compound has the chemical name: 6α,9α-Difluoro-17α-(1-oxopropoxy)-11β-hydroxy-16α-methyl-3-oxo-androsta-1,4-diene-17β-carbothioic acid S-fluoromethyl ester (fluticasone propionate). Another suitable glucocorticoid compound has the chemical name: 6α,9α-difluoro-17α-[(2-furanylcarbonyl)oxy]-11β-hydroxy-16α-methyl-3-oxo-androsta-1,4-diene-17β-carbothioic acid S-fluoromethyl ester. A further suitable glucocorticoid compound has the chemical name: 6α,9α-Difluoro-11β-hydroxy-16α-methyl-17α-[(4-methyl-1,3-thiazole-5-carbonyl)oxy]-3-oxo-androsta-1,4-diene-17β-carbothioic acid S-fluoromethyl ester.

Other suitable anti-inflammatory compounds include NSAIDs e.g. PDE4 inhibitors, leukotriene antagonists, iNOS inhibitors, tryptase and elastase inhibitors, beta-2 integrin antagonists and adenosine 2a agonists.

The medicament is formulated as any suitable fluid formulation, particularly a solution (e.g. aqueous) formulation or a suspension formulation, optionally containing other pharmaceutically acceptable additive components. The formulation may contain a preservative, although the sealed system of the dispenser may negate the need for this.

The medicament formulation may incorporate two or more medicaments.

The dispenser herein is suitable for dispensing fluid medicament formulations for the treatment of inflammatory and/or allergic conditions of the nasal passages such as rhinitis e.g. seasonal and perennial rhinitis as well as other local inflammatory conditions such as asthma, COPD and dermatitis.

A suitable dosing regime would be for the patient to inhale slowly through the nose subsequent to the nasal cavity being cleared. During inhalation the formulation would be applied to one nostril while the other is manually compressed. This procedure would then be repeated for the other nostril. Typically, one or two inhalations per nostril would be administered by the above procedure up to three times each day, ideally once daily. Each dose, for example, may deliver 5 μg, 50 μg, 100 μg, 200 μg or 250 μg of active medicament. The precise dosage is either known or readily ascertainable by those skilled in the art.

It will be understood by the skilled reader in the art that the present invention is not limited to the embodiment herein described with reference to the FIGURES of drawings, but may be varied to adopt other guises within the scope of the appended claims. As an example, the dispenser of the invention need not be hand-held, nor hand-operable. Furthermore, the dispenser may be used to deliver any number of different fluid products, medicinal and non-medicinal, as outlined previously. Additionally, the dispenser may form an internal part of a device unit so that the dispenser delivers a metered volume of the fluid product to another internal part of the device unit. For instance, the unit may be a dispenser unit including the dispenser and the metered volume is delivered to conveying means in the dispenser unit which conveys the fluid product to an outlet orifice of the unit for discharge from the unit to the surrounding environment. The conveying means may be such as to change the state of the fluid, e.g. the conveying means may have a vibrating element, e.g. a mesh, which converts a metered volume of liquid to an aerosol or mist which is then directed out of the outlet orifice. The vibrating element could, for example, be a piezoelectric element or mesh.

1. A dispenser for dispensing a metered volume of a fluid product having:
(a) a storage chamber for storing the fluid product in;
(b) an outlet orifice through which the fluid product is dispensable from the dispenser; and
(c) a dispensing mechanism adapted in use to dispense a metered volume of the fluid product from the storage chamber through the outlet orifice;
wherein the dispensing mechanism has:
(i) a metering chamber which is adapted in use to provide the metered volume of the fluid product for discharge through the outlet orifice, the metering chamber being movable between:
a first volumetric state, in which the metering chamber has a first volume greater than the metered volume and is in fluid communication with the storage chamber such that, in use, an excess volume of the fluid product consisting of the metered volume and a surplus volume is transferable to the metering chamber from the storage chamber, and
a second volumetric state, in which the metering chamber has a second volume less than the first volume and no less than the metered volume and is isolated from the storage chamber such that, in use, the metered volume of the fluid product is contained in the metering chamber ready for dispensing through the outlet orifice; and
(ii) a bleed arrangement adapted in use to bleed the surplus volume of the fluid product from the metering chamber as its moves from the first volumetric state to the second volumetric state.

2. The dispenser of claim 1 in which the second volume defines the metered volume.

3. The dispenser of claim 1, wherein the metering chamber has a boundary wall structure, the metering and storage chambers are placed in fluid communication through a port structure in the boundary wall structure and the port structure is selectively opened and closed when the metering chamber is in its first and second volumetric states, respectively.

4. The dispenser of claim 3, wherein the boundary wall structure has first and second wall members and the metering chamber is movable between its first and second volumetric states by relative movement of the first and second wall members between first and second positions, respectively.

5. The dispenser of claim 4, wherein the port structure is formed in the second wall member and wherein the first wall member is spaced from the port structure in the first position and closes the port structure in the second position.

6. The dispenser of claim 1, wherein the metering chamber is further movable from the second volumetric state to a third volumetric state which has a volume less than the second volume, movement of the metering chamber from the second to third volumetric states causing dispensing of the metered volume through the outlet orifice.

7. The dispenser of claim 6, wherein the metering chamber has a boundary wall structure, the metering and storage chambers are placed in fluid communication through a port structure in the boundary wall structure and the port structure is selectively opened and closed when the metering chamber is in its first and second volumetric states, respectively, and wherein the port structure remains shut during movement from the second to third volumetric states.

8. The dispenser of claim 1 in which the metering chamber is reversibly movable between its different volumetric states thereby enabling the dispenser to dispense multiple metered volumes of the fluid product.

9. The dispenser of claim 6, wherein the metering chamber has a boundary wall structure, the metering and storage chambers are placed in fluid communication through a port structure in the boundary wall structure and the port structure is selectively opened and closed when the metering chamber is in its first and second volumetric states, respectively, wherein the boundary wall structure has first and second wall members and the metering chamber is movable between its first and second volumetric states by relative movement of the first and second wall members between first and second positions, respectively, and wherein the metering chamber is movable between the second and third volumetric states by relative movement of the first and second wall members between the second position and a third position.

10. The dispenser of claim 9, wherein the first wall member is adapted so as to keep the port structure closed between the second and third positions.

11. The dispenser of claim 4, wherein the first and second wall members are respectively movable and static wall members of the dispenser.

12. The dispenser of claim 1 further having a valve mechanism which acts to close the outlet orifice when the metering chamber is between the first and second volumetric states.

13. The dispenser of claim 12, wherein the metering chamber is further movable from the second volumetric state to a third volumetric state which has a volume less than the second volume, movement of the metering chamber from the second to third volumetric states causing dispensing of the metered volume through the outlet orifice in which the valve mechanism further acts to open the outlet orifice when the metering chamber moves from its second volumetric state to its third volumetric state.

14. The dispenser of claim 13 in which the valve mechanism is such as to return to a closed position in which it closes the outlet orifice when the metering chamber reaches its third volumetric state.

15. The dispenser of claim 12 in which the valve mechanism is a non-return valve.

16. The dispenser of claim 12 in which the valve mechanism has a flap structure overlying the outlet orifice which selectively adopts opening and closing positions on the outlet orifice in response to the volumetric state of the metering chamber.

17. The dispenser of claim 1 in which the outlet orifice is a spray-head.

18. The dispenser of claim 1 in which the bleed arrangement is adapted in use to bleed the surplus volume of the fluid product in the metering chamber to the storage chamber.

19. The dispenser of claim 18, wherein the metering chamber has a boundary wall structure, the metering and storage chambers are placed in fluid communication through a port structure in the boundary wall structure and the port structure is selectively opened and closed when the metering chamber is in its first and second volumetric states, respectively, and wherein the bleed arrangement is adapted in use to bleed the surplus volume of the fluid product to the storage chamber through the port structure.

20. The dispenser of claim 1 in which movement of the metering chamber from its second volumetric state to its first volumetric state is such as to cause fluid product held in the storage chamber to be transferred to the metering chamber.

21. The dispenser of claim 1 wherein the storage chamber moves from an expanded volumetric state to a contracted volumetric state in response to the metering chamber moving from the second volumetric state towards its first volumetric state.

22. The dispenser of claim 21 in which the storage chamber is reversibly movable to the expanded volumetric state in response to the metering chamber moving from its first volumetric state towards the second volumetric state.

23. The dispenser of claim 21 in which the storage chamber is caused to move between its expanded and contracted volumetric states by pressures created by movement of the metering chamber between its first and second volumetric states.

24. The dispenser of claim 23, further having a valve mechanism which acts to close the outlet orifice when the metering chamber is between the first and second volumetric states, wherein the valve mechanism has an opening pressure threshold which is greater than the pressure needed to move the storage chamber from its contracted state to its expanded state whereby the valve mechanism remains in a closed position during movement of the metering chamber from its first volumetric state to its second volumetric state.

25. The dispenser of claim 21 in which the volume of the expanded volumetric state of the storage chamber decreases after each metered volume dispensed.

26. The dispenser of claim 21 in which the storage chamber has a boundary wall structure having first and second wall members which move relative to one another between first and second positions to bring the storage chamber to its expanded and contracted volumetric states, respectively.

27. The dispenser of claim 26, wherein the metering chamber has a boundary wall structure, the metering and storage chambers are placed in fluid communication through a port structure in the boundary wall structure and the port structure is selectively opened and closed when the metering chamber is in its first and second volumetric states, respectively in which the port structure is located in the first wall member of the storage chamber with the second wall member of the storage chamber being spaced from the port structure in the first position.

28. The dispenser of claim 27 wherein the spacing of the second wall member from the port structure when in the first position decreases after each metered volume dispensed.

29. The dispenser of claim 1 which is hand-held with the dispensing mechanism hand-operable.

30. The dispenser of claim 9, in which the first wall member of the metering chamber is operatively connected to an actuating arrangement which in a first mode of operation moves the first wall member to the first position and in a second mode of operation moves the first wall member to the third position.

31. The dispenser of claim 30 in which the first wall member of the metering chamber forms the head of a plunger structure of the actuating arrangement which is mounted for reciprocal movement in the dispenser for moving the head between the different positions relative to the second wall member.

32. The dispenser of claim 4 in which the first wall member of the metering chamber forms an end wall of the metering chamber which is mounted for sealing slidable movement on the second wall member.

33. The dispenser of claim 26 in which the second wall member of the storage chamber forms an end wall of the storage chamber which is mounted for sealing slidable movement on the first wall member.

34. The dispenser of claim 30, wherein the actuating arrangement has a biasing member which biases the first wall member of the metering chamber to the third position in the second mode of operation.

35. The dispenser of claim 1 having a fluid product contained in the storage chamber.

36. The dispenser of claim 35 in which the fluid product is selected from the group consisting of a liquid, a viscous product, a powder and a gas.

37. The dispenser of claim 35 in which the fluid product is a medicament.

38. A dispenser unit having a dispenser according to claim 1 in which the outlet orifice is an outlet orifice of the unit through which the metered volume of the fluid product is, in use, dispensed to the external environment.

39. A device unit having a dispenser according to claim 1, wherein the outlet orifice is an internal orifice of the unit through which, in use, the metered volume of the fluid product is dispensed into the unit.

40. The device unit of claim 39 further having an outlet orifice which opens to the external environment about the unit and means for conveying the fluid product dispensed through the internal orifice to the external environment through the outlet orifice.

41. The device unit of claim 40 in which the conveying means is such as to change the state of the fluid product.

42. The device unit of claim 40 in which the conveying means has a vibrating element to aerosolise a liquid dispensed by the dispenser.

43. The device unit of claim 42 in which the vibrating element is a piezoelectric element.

44. (canceled)
